(19) United States
(12) Patent Application Publication
(10) Pub. No.: US 2026/0276055 A1
(43) Pub. Date: Sep. 17, 2026

(54) DAMPING FORCE GENERATION DEVICE

(71) Applicant: Astemo, Ltd., Tokyo (JP)

(72) Inventors: Gota NAKANO, Hitachinaka-shi (JP); Chikara YANAGISAWA, Hitachinaka-shi (JP)

(73) Assignee: Astemo, Ltd., Tokyo (JP)

(21) Appl. No.: 19/166,346

(22) PCT Filed: Dec. 19, 2023
(86) PCT No.: PCT/JP2023/045458

§ 371 Date: Sep. 17, 2025

(30) Foreign Application Priority Data
May 19, 2023 (JP) 2023-083530

(51) Int. Cl. F16F 9/512; F16K 31/06

(52) U.S. Cl. CPC F16F 9/5126; F16K 31/06

(57) ABSTRACT

A damping force generation device includes: a valve limiting the flow of oil and generating damping force; a back pressure chamber applying pressure in a valve closing direction to the valve; a discharge flow path allowing oil to flow out from the back pressure chamber; a valve on the discharge flow path including a control valve varying the area of the discharge flow path and a control seat on which the control valve can be seated; a pressing part that can contact with a side of the control valve opposite a side facing the control seat; a coil spring causing bias in a direction that the control seat and the control valve approach each other; and a solenoid part applying thrust toward the control seat to the control valve via the pressing part.

### CROSS-REFERENCE TO RELATED PATENT APPLICATIONS

This application is a U.S. National Phase Application under 35 U.S.C. § 371 of International Patent Application No. PCT/JP 2023/045458 filed on Dec. 19, 2023, which claims the benefit of priority to Japanese Patent Application No. 2023-083530 filed May 19, 2023 and International Patent Application No. PCT/JP 2023/018847 filed on May 19, 2023, all of the contents of which are incorporated herein by reference in their entireties. The International Patent Application was published in Japanese on Nov. 28, 2024 as International Publication No. WO/ 2024/241615 under PCT Article 21(2).

### FIELD OF THE INVENTION

The present invention relates to a damping force generation device.

### BACKGROUND OF THE INVENTION

For example, the damping valve described in Japanese Patent Application Laid-Open Publication No. 2017-57864has a valve body member including a pressure control valve body that is left from and seated at the pressure control valve seat and an opening and closing valve body that is left from and seated at the opening and closing valve seat, the valve body member opening and closing the upstream and downstream sides of a pilot path. In addition, the damping valve described in Japanese Patent Application Laid-Open Publication No. 2017-57864has a disc spring that is mounted between a step and the valve body member, the disc spring separating the pressure control valve body from the pressure control valve seat and biasing the valve body member in the direction that the opening and closing valve body approaches the opening and closing valve seat, and a solenoid that can drive the valve body member against the biasing force of the disc spring. Then, in the case where the current is supplied to the solenoid and thrust is applied to the valve body member for pressing the pressure control valve body of the valve body member against the pressure control valve seat opposing the biasing force of the disc spring, when the resultant of the force, which separates the pressure control valve body from the pressure control valve seat due to the pressure of a rod side chamber, and the biasing force of the disc spring exceeds the thrust of the solenoid, the pressure control valve is opened, and thereby the pilot path is opened. Therefore, the valve-opening pressure of the pressure control valve can be adjusted by adjusting the thrust of the solenoid with a large or small amount of current supplied to the solenoid. Then, when the pressure control valve is opened, the pressure in the pilot path upstream of the pressure control valve becomes equal to the valve-opening pressure of the pressure control valve, and the internal pressure in the back pressure chamber where the pressure in the pilot path upstream of the pressure control valve is introduced is also controlled to the valve-opening pressure. In the case where the internal pressure of the back pressure chamber is lowered, the damping force can be lowered by reducing the valve-opening pressure of an auxiliary valve body and a main valve body, and when the internal pressure of the back pressure chamber is increased, the damping force can be increased by increasing the valve-opening pressure of the auxiliary valve body and the main valve body.

### CITATION LIST

### Patent Literature

Patent Document 1: Japanese Patent Application Laid-Open Publication No. 2017-57864

In the damping valve described in Japanese Patent Application Laid-Open Publication No. 2017-57864, even if the thrust is applied to the valve body member by supplying current to the solenoid, for example, when the piston speed is large, the resultant of the force that causes the pressure control valve body to be released from the pressure control valve seat and the biasing force of the disc spring exceeds the thrust of the solenoid, and the valve body member is seated in the opening and closing valve seat. Therefore, even if current is supplied to the solenoid and thrust is applied to the valve body member, the operating mode shifts to the same one as in the abnormal state when current to the solenoid is cut off. From the viewpoint of the damping force performance, it is desirable to prevent the operation for the abnormal state even though the mechanism can operate normally, and also to enable the operation for the abnormal state only when an actual abnormality occurs in the mechanism.

An object of the present invention is to provide a damping force generating device, etc. that can suppress an operation in an abnormal state even though a mechanism can operate normally.

### SUMMARY OF THE INVENTION

The present invention completed under the above object provides a damping force generation device including: a first valve restricting flow of a fluid and generating a damping force; a back pressure chamber applying pressure in a closing direction to the first valve; a flow path through which the fluid flows out of the back pressure chamber; a second valve provided on the flow path and including a valve body capable of varying an area of the flow path and a valve seat on which the valve body can be seated; a pressing part capable of contacting a side of the valve body opposite to a side thereof facing the valve seat; a biasing member causing bias in a direction in which the valve seat and the valve body approach each other; and an actuator part applying thrust to the valve body through the pressing part, the thrust heading to the valve seat.

### ADVANTAGEOUS EFFECTS OF INVENTION

According to the present invention, it is possible to suppress an operation in an abnormal state even though a mechanism can operate normally.

### BRIEF DESCRIPTION OF THE DRAWINGS

FIG. 1 is a diagram showing an example of an overall configuration of a hydraulic shock absorbing device related to a first exemplary embodiment;

FIG. 2 is a diagram showing an example of a cross section of a damping force generation device in the first exemplary embodiment;

FIG. 3 is a diagram showing an example of a perspective cross section of a main valve part and a damping force adjusting part in the first exemplary embodiment;

FIG. 4 is a diagram showing an example of a partial cross section of the main valve part and the damping force adjusting part in the first exemplary embodiment;

FIG. 5 is a diagram showing an example of oil flow when a moving speed of a piston part is low in the state where a pressing force of a pressing member is minimized;

FIG. 6 is a diagram showing an example of the oil flow when the moving speed of the piston part is high in the state where the pressing force of the pressing member is minimized;

FIG. 7 is a diagram showing an example of the oil flow when the moving speed of the piston part is low in the state where the pressing force of the pressing member is maximized;

FIG. 8 is a diagram showing an example of the oil flow when the moving speed of the piston part is high in the state where the pressing force of the pressing member is maximized;

FIG. 9 is a diagram showing an example of the oil flow when the moving speed of the piston part is low in the state where a solenoid part is not energized;

FIG. 10 is a diagram showing an example of the oil flow when the moving speed of the piston part is high in the state where the solenoid part is not energized;

FIG. 11 is a diagram showing an example of an overall configuration of a damping force generation device related to a second exemplary embodiment;

FIG. 12 is a diagram showing an example of an overall configuration of a damping force generation device related to a third exemplary embodiment;

FIG. 13 is a diagram showing an example of an overall configuration of a damping force generation device related to a fourth exemplary embodiment;

FIG. 14 is a diagram showing an example of the pressing member viewed from a second side to a second axial direction;

FIG. 15A is a diagram showing an example of an overall configuration of the pressing member and a plunger related to a modified example, and FIG. 15B is an example of a diagram of the plunger related to the modified example viewed from a first side to the second axial direction.

### DETAILED DESCRIPTION OF THE INVENTION

Hereinafter, exemplary embodiments according to the present invention will be described in detail with reference to attached drawings.

### First Exemplary Embodiment

Configuration and function of hydraulic shock absorbing device 1

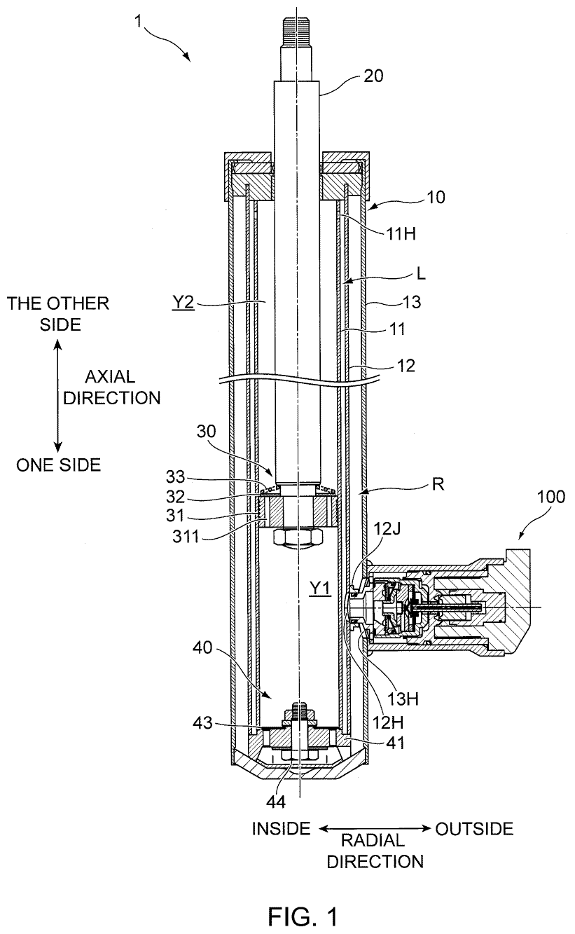

FIG. 1 is a diagram showing an example of an overall configuration of a hydraulic shock absorbing device 1 related to a first exemplary embodiment.

As shown in FIG. 1, the hydraulic shock absorbing device 1 includes a cylinder part 10 containing oil and a rod 20 with one end slidably inserted into the cylinder part 10 and the other end protruding from the cylinder part 10. In addition, the hydraulic shock absorbing device 1 includes a piston part 30 provided at one end portion of the rod 20 and a bottom part 40 provided at one end portion of the cylinder part 10. Furthermore, the hydraulic shock absorbing device 1 includes a damping force generation device 100 provided outside the cylinder part 10 to generate a damping force.

Note that, in the following description, the longitudinal direction of the cylinder part 10 shown in FIG. 1 is referred to as an “axial direction,” the lower side of FIG. 1 in the axial direction is referred to as “one side,” and the upper side of FIG. 1 is referred to as “the other side” in some cases. In addition, the left and right direction of the cylinder part 10 shown in FIG. 1 is referred to as the “radial direction”, and in the radial direction, the center axis side of the cylinder part 10 is referred to as “inside”, and the side away from the center axis is referred to as “outside” in some cases.

The cylinder part 10 includes a cylinder 11 containing oil, an outer cylindrical body 12 provided at the outside of the cylinder 11, and a damper case 13 provided at further outside of the outer cylindrical body 12.

The cylinder 11 is formed cylindrically with a communicating hole 11H at an end part on the other side, which connects the inside and the outside.

The outer cylindrical body 12 is formed cylindrically. Then, the outer cylindrical body 12 forms a communication path L between the cylinder 11 and the outer cylindrical body 12. In addition, the outer cylindrical body 12 has an outer cylindrical body opening part 12H and an outer connection part 12J at a position facing the damping force generation device 100. The outer connection part 12J has an oil flow path and protrudes outward to form a connecting portion with the damping force generation device 100.

The damper case 13 is formed cylindrically. The damper case 13 forms a reservoir chamber R, in which oil accumulates, between the outer cylindrical body 12 and the damper case 13. The reservoir chamber R absorbs oil in the cylinder 11 or supplies oil into the cylinder 11 as the rod 20 moves relative to the cylinder 11. In addition, the reservoir chamber R also collects oil flowing from the damping force generation device 100. Moreover, the damper case 13 has a case opening part 13H at a position facing the damping force generation device 100.

The rod 20 is a rod-like member extending long in the axial direction. The rod 20 holds the piston part 30 on one side. In addition, the rod 20 connects to, for example, the vehicle body on the other side through a not-shown coupling member, etc.

The piston part 30 includes: a piston body 31 with plural piston oil ports 311; a piston valve 32 opening and closing the other side of the piston oil ports 311; and a spring 33 provided between the piston valve 32 and an end of the rod 20 on one side. Then, the piston part 30 divides the oil in the cylinder 11 into a first oil chamber Y1 and a second oil chamber Y2.

The bottom part 40 includes a valve seat 41, a check valve part 43 provided on the other side of the valve seat 41, and a fixing member 44 provided in the axial direction. Then, the bottom part 40 separates the first oil chamber Y1 and the reservoir chamber R.

### Configuration and Function of Damping Force Generation Device 100

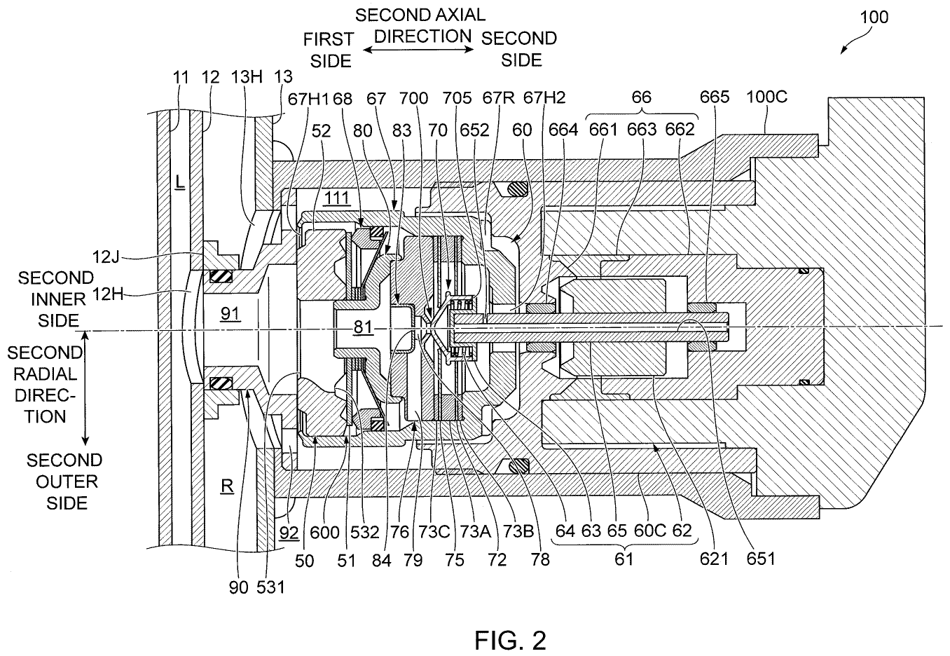

FIG. 2 is a diagram showing an example of a cross section of the damping force generation device 100 in the first exemplary embodiment.

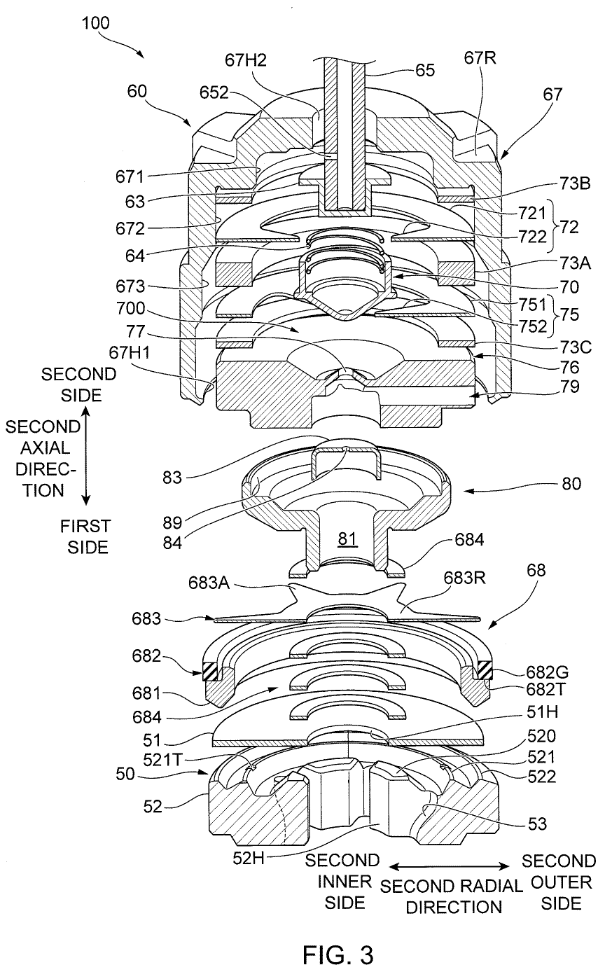

FIG. 3 is a diagram showing an example of a perspective cross section of a main valve part 50 and a damping force adjusting part 60 in the first exemplary embodiment.

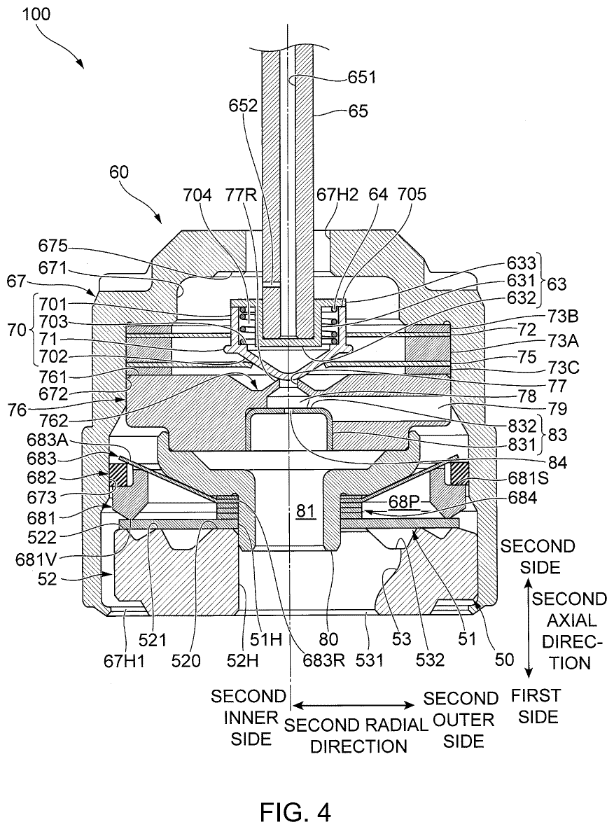

FIG. 4 is a diagram showing an example of a partial cross section of the main valve part 50 and the damping force adjusting part 60 in the first exemplary embodiment.

In the following description, the longitudinal direction of the damping force generation device 100 shown in FIG. 2 (that is, an intersecting direction intersecting the axial direction of the cylinder part 10 (refer to FIG. 1) (for example, substantially an orthogonal direction)) is referred to as a “second axial direction” in some cases. In addition, the center axis side of the cylinder part 10 (left side of the damping force generation device 100 in FIG. 2) in the second axial direction is referred to as the “first side”, and the side away from the center axis of the cylinder part 10 (right side of the damping force generation device 100 in FIG. 2) is referred to as the “second side” in some cases.

Moreover, the short direction of the damping force generation device 100 shown in FIG. 2 (that is, a direction intersecting the second axial direction) is sometimes referred to as a “second radial direction.” Then, in the second radial direction, the center axis side along the second axis is referred to as a “second inner side,” and the side moving away from the center axis along the second axis is referred to as a “second outer side” in some cases.

As shown in FIG. 2, the damping force generation device 100 includes the main valve part 50 mainly generating the damping force in the hydraulic shock absorbing device 1 in the first exemplary embodiment, and the damping force adjusting part 60 adjusting the magnitude of the damping force generated in the damping force generation device 100. Furthermore, the damping force generation device 100 includes: a communication part 80 forming a parallel flow path with respect to the main valve part 50; a connection flow path part 90 forming a flow path of oil from the communication path L with respect to the main valve part 50 and the communication part 80; and an outer housing 100C housing various components constituting the damping force generation device 100.

### Main Valve Part 50

The main valve part 50 includes a main valve 51 generating the damping force by controlling the oil flow to narrow thereof, and a main valve seat 52 facing the main valve 51 and which the main valve 51 contacts.

As shown in FIG. 3, the main valve 51 has an opening part 51H at the second inner side and is a disc-shaped member that elastically deforms. As a material of the main valve 51, for example, metal such as iron can be used.

As shown in FIG. 4, the opening part 51H of the main valve 51 is penetrated by the communication part 80. In addition, the main valve 51 is sandwiched between the main valve seat 52 and a spacer member 684 (described later) on the second inner side. Then, the main valve 51 faces the second side of the main valve seat 52.

Movement of the position of the main valve 51, which is configured as described above, in the second radial direction is restricted by the communication part 80. In addition, movement of the second inner side of the main valve 51 in the second axial direction is restricted by the main valve seat 52 and the spacer member 684 (described later). On the other hand, the second outer side of the main valve 51 is movable in the second axis direction by deforming. Then, the main valve 51 generates the damping force by narrowing the oil flow in a main flow path 53, which will be described later, in the main valve seat 52. The main valve 51 and main valve seat 52 constitute a valve 600 which varies the area of the flow path of oil flowing through the main flow path 53 into the reservoir chamber R.

Subsequently, the main valve seat 52 will be described.

As shown in FIG. 3, the main valve seat 52 is a cylindrical member having an opening part 52H at the second inner side. Then, the communication part 80 is inserted into a part of the opening part 52H of the main valve seat 52 (see FIG. 4).

The main valve seat 52 has a center seat part 520 around the opening part 52H. In addition, the main valve seat 52 includes an inner seat part 521, which is provided toward the second outer side than the center seat part 520, and an outer seat part 522, which is provided toward the second outer side than the inner seat part 521. Furthermore, the main valve seat 52 has the main flow path 53 penetrating in the second axial direction at the second outer side of the opening part 52H.

The center seat part 520 protrudes in an arc shape toward the main valve 51 side. A portion in the main valve 51 in the second inner side then faces the center seat part 520.

The inner seat part 521 is formed into an annular shape. The inner seat part 521 protrudes more toward the main valve 51 side than a flow path port 532. In addition, the protrusion height of the inner seat part 521 is substantially the same as that of the center seat part 520 and the outer seat part 522.

The outer seat part 522 is formed into an annular shape. The outer seat part 522 protrudes more toward the main valve 51 side than the flow path port 532.

The inner seat part 521 and the outer seat part 522 form a contact portion with the main valve 51.

Furthermore, the inner seat part 521 includes plural groove parts 521T formed along the second radial direction. The cross-sectional area of the flow path in each of the groove parts 521T is formed relatively small. In other words, the groove parts 521T constitute the so-called orifice flow path. Each groove 521T forms a flow path of the oil from the second inner side of the inner seat part 521 to the second outer side of the inner seat part 521, with the main valve 51 being in contact with the inner seat part 521.

The main flow path 53 constitutes a parallel flow path to a back pressure flow path 77 of a control seat 76 to be described later (see FIG. 4). In addition, plural main flow paths 53 are provided in the circumferential direction (see FIG. 3). Then, a flow path port 531 on the first side of each main flow path 53 communicates with the opening part 52H and faces the connection flow path part 90. In addition, a flow path port 532 on the second side of each main flow path 53 is located between the center seat part 520 and the inner seat part 521.

Damping force adjusting part 60

As shown in FIG. 2, the damping force adjusting part 60 includes: a forward/backward part 61 that allows a control valve 70, which will be described later, to move forward and backward with respect to the control seat 76; a cap part 67 that covers various components such as the main valve part 50; and a back pressure generation mechanism 68 that changes the deformability of the main valve 51 against the main valve seat 52. The damping force adjusting part 60 also includes: the control valve 70 that controls the oil flow at the communication part 80; the control seat 76 that is a valve seat facing the control valve 70 and which the control valve 70 contacts; and a narrowing member 83 that narrows the oil flow. In addition, the damping force adjusting part 60 includes: a regulation member 72 that regulates the movement of the control valve 70 toward the second side; and a biasing member 75 that applies a force in the direction against the thrust of the solenoid part 62 to the control valve 70. Moreover, the damping force adjusting part 60 includes: a first spacer member 73A that mediates between the biasing member 75 and the regulation member 72; a second spacer member 73B that exists between the regulation member 72 and the cap part 67; and the third spacer member 73C, which is mediated between the control seat 76 and the biasing member 75.

### Forward/Backward Part 61

As shown in FIG. 2, the forward/backward part 61 includes: a solenoid part 62 that allows a pressing member 63, which will be described later, to move forward and backward using an electromagnet; the pressing member 63 that presses the control valve 70 against the control seat 76; and a coil spring 64 provided between the pressing member 63 and the control valve 70. The forward/backward part 61 also includes a solenoid case 60C that contains and supports the components constituting the forward/backward part 61, and a fixed part 66 that movably supports a plunger 65, to be described later, in the second axial direction together with the solenoid case 60C.

The fixed part 66 includes, an example of a mode, a first fixed part 661, which is a portion on the second inner side in the solenoid case 60C, a second fixed part 662 provided closer to the second side than the first fixed part 661, and a spacer 663 provided between the first fixed part 661 and the second fixed part 662.

The solenoid part 62 includes a plunger 65 that moves forward and backward along the second axial direction and pushes the plunger 65 toward the first side when the electromagnet is energized. The plunger 65 is pulled back toward the second side by the coil spring 64 when the solenoid part 62 is not energized. The plunger 65 is movably supported in the second axial direction by a first bearing 664 provided on the second inner side of the first fixed part 661 and a second bearing 665 provided on the second inner side of the second fixed part 662. The plunger 65 is in the cylindrical shape. In other words, in the plunger 65, a through hole 651 that penetrates from the first side to the second side is formed on the second inner side of a column. In a portion in the plunger 65 on the first side than the first bearing 664, a communicating hole 652 penetrating in the second radial direction is formed to communicate the inside and the outside. Through the communicating hole 652, the outside of the portion of the plunger 65, which is on the first side than the first bearing 664, and the portion on the second inner side of the second fixed part 662, which is on the second side than the second bearing 665, have the same pressure.

The pressing member 63 includes: a cylinder-shaped cylindrical part 631; a bottom part 632 covering the opening part of the cylindrical part 631 on the first side; and a flange part 633 that is provided at the end part of the cylindrical part 631 on the second side and protrudes toward the second outer side over the entire circumference, as shown in FIG. 4. The cylindrical part 631 and the bottom part 632 function as a cover part that covers a predetermined range of the end portion on the first side of the plunger 65 and closes the opening part on the first side of the through hole 651. The flange part 633 contacts an end surface 705 on the second side of a cylindrical part 701, which will be described later, of the control valve 70. Therefore, the pressing member 63, together with the plunger 65, functions as a pressing part that can contact the side opposite to the side facing the control seat 76 in the control valve 70. Note that the pressing member 63 can be exemplified as an article molded by applying press working to sheet metal.

The coil spring 64 is a compression coil spring that is in contact with the control valve 70 on the first side and is in contact with the pressing member 63 on the second side. The coil spring 64 then applies a force to each of the pressing member 63 and the control valve 70 in the direction in which the pressing member 63 and the control valve 70 are separated from each other. Note that, in place of the coil spring 64, other members, such as elastic rings, can be used as long as they perform the similar function.

### Cap Part 67

As shown in FIG. 3, the cap part 67 includes a first opening part 67H1 formed on the first side and a second opening part 67H2 formed on the second side, and the approximate contour of the cap part 67 is cylindrical. In addition, the inner diameter of the first opening part 67H1 is formed larger than the inner diameter of the second opening part 67H2. Furthermore, plural inner diameter parts with different inner diameters are formed inside the cap part 67. Among the plural inner diameter parts, the inner diameter part provided on the first side is formed so that the inner diameter is larger than that of the inner diameter part provided on the second side. For example, the cap part 67 has a first inner diameter part 671 on the first side than the second opening part 67H2, a second inner diameter part 672 on the first side than the first inner diameter part 671, and a third inner diameter part 673 on the first side than the second inner diameter part 672.

As shown in FIG. 4, the cap part 67 contains the main valve part 50, the damping force adjusting part 60, and the communication part 80 therein. In more detail, the cap part 67 contains the main valve 51 of the main valve part 50 and the control valve 70. In addition, a part of the cap part 67, together with the back pressure generation mechanism 68 and the control seat 76, forms the back pressure chamber 68P, which applies an oil pressure (hereinafter sometimes referred to as “back pressure”) to the main valve 51 from the second side opposite to the main valve seat 52.

As shown in FIG. 2, the cap part 67 is pinched between the solenoid case 60C and the connection flow path part 90 to be fixed. The cap part 67 also forms a cap flow path 67R where oil flows between the cap part 67 and the solenoid case 60C. The cap flow path 67R communicates with the second opening part 67H2, and an in-housing flow path 111 which will be described later.

Furthermore, in the cap part 67, the plunger 65 is provided to penetrate through the second opening part 67H2. In addition, inside the cap part 67, the pressing member 63 moves forward and backward with respect to the second opening part 67H2.

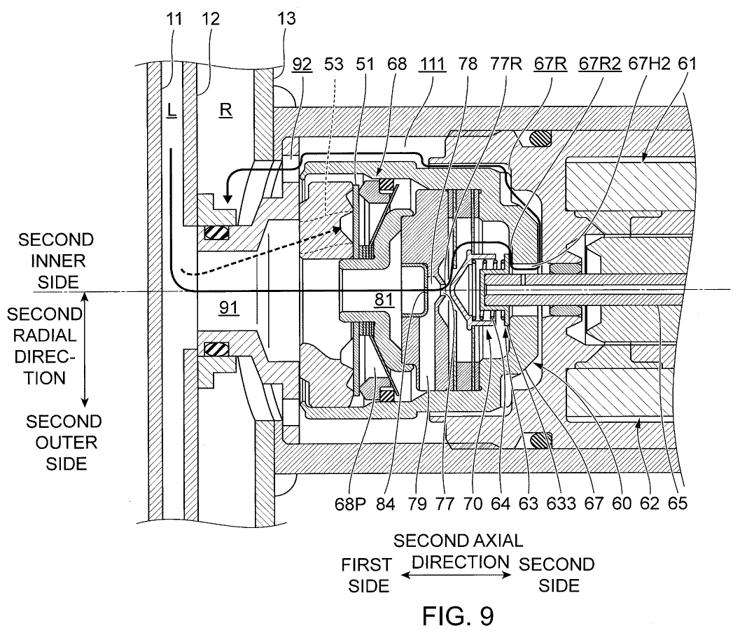

A groove part 675 is then formed on the edge of the first side of the second opening part 67H2 of the cap part 67. In the state in which the pressing member 63 moves to the second side and contacts the cap part 67, the groove part 675 forms a cap orifice flow path 67R2 (see FIG. 9) through which oil flows between the flange part 633 of the pressing member 63 and the cap part 67. The cap orifice flow path 67R2 communicates with the cap flow path 67R via the second opening part 67H2.

In the first exemplary embodiment, the cross section of the oil flow path in the groove part 675 is set to increase the pressure in the back pressure chamber 68P above a certain level when the solenoid part 62 is not energized. Furthermore, the cross section of the oil flow path in the groove part 675 is set to allow oil to flow to the groove part 675 to the extent that the main valve 51 opens the main flow path 53 to allow oil to flow when the solenoid part 62 is not energized.

The configuration that causes the oil flow between the cap part 67 and the pressing member 63 during the state described above in which the solenoid part 62 is not energized is not limited to the groove part 675. For example, a groove part provided in the pressing member 63 may provide the oil flow between the pressing member 63 and the cap part 67 in the state in which the pressing member 63 is in contact with the cap part 67. Alternatively, a configuration may be possible in which, in addition to the groove part 675 being formed in the cap part 67, a groove part is provided in the pressing member 63. Furthermore, the configuration that causes the oil flow between the pressing member 63 and the cap part 67 in the state in which the pressing member 63 is in contact with the cap part 67 is not limited to the groove part and may be a through hole.

### Back Pressure Generation Mechanism 68

As shown in FIG. 3, the back pressure generation mechanism 68 includes a partition member 681 provided on the opposite side of the main valve seat 52 with respect to the main valve 51, namely, the second side, and a seal member 682 that seals between the cap part 67 and the partition member 681. Further, the back pressure generation mechanism 68 includes a return spring 683 that provides a force to the partition member 681 that presses the partition member 681 against the main valve 51, and the spacer member 684 that mediates between the return spring 683 and the main valve 51.

The approximate contour of the partition member 681 is formed into a substantially annular shape. The partition member 681 is movable in the second axial direction. For example, the partition member 681 moves toward the second side when the main valve 51 deforms toward the second side. The partition member 681 also moves toward the first side when the main valve 51 deforms toward the first side.

Further, the partition member 681 includes a main valve contact part 681V that contacts the main valve 51, and a seal contact part 681S on which a seal member 682 is to be provided.

The main valve contact part 681V is provided on the first side in the partition member 681. The main valve contact part 681V is formed so that the width thereof gradually decreases from the second side to the first side. The main valve contact part 681V makes an annular contact with the main valve 51. The partition member 681 constitutes one of the components that form the back pressure chamber 68P.

Here, the back pressure chamber 68P is a chamber which, when oil enters therein, applies a hydraulic pressure corresponding to the entered oil to the main valve 51. The back pressure chamber 68P then acts to provide a force on the main valve 51 that presses the main valve 51 against the main valve seat 52.

As shown in FIG. 3, the seal member 682 is formed into an annular shape. In addition, resin materials that deform elastically, such as engineering plastics and rubber, can be used for the seal member 682.

Then, as shown in FIG. 4, the seal member 682 seals between the partition member 681 and the third inner diameter part 673 of the cap part 67. In more detail, the outer circumferential surface 682G of the seal member 682 contacts the inner circumference of the third inner diameter part 673 of the cap part 67. In addition, the end surface 682T on the first side of the seal member 682 contacts the partition member 681. This allows the seal member 682 to suppress oil in the back pressure chamber 68P flowing out of the back pressure chamber 68P through the gap between the partition member 681 and the cap part 67.

As shown in FIG. 3, the return spring 683 includes an annular part 683R formed annularly and plural arm parts 683A protruding from the annular part 683R toward the second outer side. In addition, as a material of the return spring 683, elastic members such as metal can be used.

As shown in FIG. 4, the communication part 80 of the return spring 683 penetrates through the annular part 683R, and the annular part 683R is sandwiched in the second axis direction by plural spacer members 684. In addition, the arm parts 683A of the return spring 683 contact the seal member 682.

In the return spring 683, the position where the annular part 683R is fixed by the spacer member 684 and the position where the arm part 683A contacts the seal member 682 are different in the second axial direction. The arm part 683A then has a shape that is inclined to the second axial direction. Further, the arm part 683A is in contact with a corner portion on the second side and the second inner side of the seal member 682. This allows the arm 683A to provide a spring force of the component along the second axial direction and a spring force of the component along the second radial direction to the seal member 682.

Further, the arm part 683A of the return spring 683 of the first exemplary embodiment is also in contact with the partition member 681. The return spring 683 then provides the spring force of the component along the second axial direction and the spring force of the component along the second radial direction to the partition member 681.

### Control Valve 70

The control valve 70 includes a cylinder-shaped cylindrical part 701, a cone-shaped conical part 702 covering the opening part on the first side in the cylindrical part 701 and protruding toward the first side. The control valve 70 also includes a protruding part 71 at the end part on the first side of the cylindrical part 701, which protrudes toward the second outer side over the entire circumference. In addition, the control valve 70 includes a flat surface 703 perpendicular to the second axial direction, which is located at an end portion on the second side in the conical part 702 and on the second inner side.

The size of the outer diameter of the cylindrical part 701 is larger than or equal to the size of the outer diameter of the flange part 633 of the pressing member 63, and the size of the inner diameter of the cylindrical part 701 is smaller than the size of the outer diameter of the flange part 633. This causes the end surface 705 on the second side of the cylindrical part 701 to be in contact with the flange part 633 of the pressing member 63.

In addition, the size of the inner diameter of the cylindrical part 701 is larger than the size of the outer diameter of the cylindrical part 631 of the pressing member 63. This causes, in the state where the end surface 705 on the second side of the cylindrical part 701 is in contact with the flange part 633 of the pressing member 63, the cylindrical part 631 and the bottom part 632 of the pressing member 63 to be contained in the second inner side of the control valve 70. The coil spring 64 (an example of an elastic member) is then disposed in space 704 (an example of spring space) formed between the cylindrical part 701 of the control valve 70 and the cylindrical part 631 of the pressing member 63. The end portion on the first side of the coil spring 64 is supported by the flat surface 703 of the control valve 70 and the end portion on the second side of the coil spring 64 is supported by the flange part 633 of the pressing member 63. In this way, the coil spring 64 is a member acting at both ends, and the thrust efficiency is optimal, not because the coil spring 64 has no fixed end, but because all of the thrust of the solenoid part 62 applied to the coil spring 64 is used to deform the coil spring 64 itself.

### Regulation Member 72

As shown in FIG. 3, the regulation member 72 includes an annular part 721 formed annularly and plural arm parts 722 protruding from the annular part 721 toward the second inner side. The four arm parts 722 are provided at regular intervals in the circumferential direction of the annular part 721. The size of the arm part 722 in the circumferential direction gradually decreases from the second outer side toward the second inner side. The diameter of a virtual circle formed by the tip end of the second inner side of the plural arm parts 722 is larger than the diameter of the outer circumference of the cylindrical part 701 of the control valve 70 and smaller than the diameter of the outer circumference of the protruding part 71.

### First Spacer Member 73A, Second Spacer Member 73B, and Third Spacer Member 73C

The first spacer member 73A, the second spacer member 73B, and the third spacer member 73C are annular members. The outer diameter of the first spacer member 73A, the second spacer member 73B, and the third spacer member 73C is larger than the inner diameter of the first inner diameter part 671 of the cap part 67 and smaller than the inner diameter of the second inner diameter part 672. In addition, the inner diameter of the first spacer member 73A, the second spacer member 73B, and the third spacer member 73C is larger than the inner diameter of the first inner diameter part 671 of the cap part 67 and smaller than the inner diameter of the second inner diameter part 672.

The first spacer member 73A and the second spacer member 73B are disposed between the end surface on the first side in the first inner diameter part 671 of the cap part 67 and the biasing member 75 and determine the position of the regulation member 72 in the second axial direction. More specifically, the regulation member 72 is located on the second side than the protruding part 71 of the control valve 70 and regulates the movement of the control valve 70 to the second side.

The position of the regulated member 72 in the second axis direction can be adjusted by adjusting the size of the first spacer member 73A and the second spacer member 73B in the second axis direction (hereinafter referred to as “thickness” in some cases). For example, in the case where the position of the regulation member 72 in the second axis direction is to be set to the first side than that in FIG. 4, it is desirable to make the thickness of the first spacer member 73A thinner than that shown in FIG. 4, and to make the thickness of the second spacer member 73B thicker than that shown in FIG. 4. On the other hand, in the case where the position of the regulation member 72 in the second axis direction is to be set to the second side than that in FIG. 4, it is desirable to make the thickness of the first spacer member 73A thicker than that shown in FIG. 4, and to make the thickness of the second spacer member 73B thinner than that shown in FIG. 4.

The third spacer member 73C is disposed between the biasing member 75 and the control seat 76 to determine the position of the biasing member 75 in the second axial direction. Then, the position of the biasing member 75 in the second axis direction can be adjusted by adjusting the size of the third spacer member 73C in the second axis direction (hereinafter referred to as “thickness” in some cases). For example, in the case where the position of the biasing member 75 in the second axis direction is to be set to the first side than that in FIG. 4, it is desirable to make the thickness of the third spacer member 73C thinner than that shown in FIG. 4, and to make the thickness of the first spacer member 73A thicker than that shown in FIG. 4. On the other hand, in the case where the position of the biasing member 75 in the second axis direction is to be set to the second side than that in FIG. 4, it is desirable to make the thickness of the third spacer member 73C thicker than that shown in FIG. 4, and to make the thickness of the first spacer member 73A thinner than that shown in FIG. 4.

### Biasing Member 75

The biasing member 75 is an annular-shaped plate spring that applies the thrust of the solenoid part 62 and force in the direction against the spring force of the coil spring 64 to the control valve 70, and the spring constant thereof is set higher than that of the coil spring 64. The biasing member 75 includes an annular part 751 formed annularly and functioning as a fixed end, and plural arm parts 752 protruding from the annular part 751 toward the second inner side and functioning as an acting end. Note that the shape of the biasing member 75 is not limited to the above, and the shape is not particularly limited if the biasing member 75 has the fixed end and the acting end acting on the control valve 70. For example, three arm parts 752 are provided at regular intervals in the circumferential direction of the annular part 751. However, the number of the arm parts 752 is not limited to three and may be two or less or four or more. In addition, the shapes of the plural arm parts 752 may all be the same or different from one another. For example, the plural arm parts 752 may have different sizes in the circumferential direction. Note that the biasing member 75 does not need to be a plate spring but may be an elastic member such as a coil spring mediated between the control valve 70 and the control seat 76.

### Control Seat 76

The control seat 76 includes: an outer seat part 761 that holds, together with the cap part 67, the regulation member 72, the biasing member 75, the first spacer member 73A, the second spacer member 73B, and the third spacer member 73C; and a concave part 762 that is recessed from a surface on the second side of the outer seat part 761, which is provided to the second inner side. In a portion at the second inner side of the concave part 762, the back pressure flow path 77 is formed, which is a through hole in the second axial direction and forms the oil flow path for adjusting the oil pressure in the back pressure chamber 68P. The control seat 76 has a round 77R around the back pressure flow path 77, which protrudes toward the second side more than the bottom part of the concave part 762.

Furthermore, the control seat 76 includes a communication chamber 78 that is provided to the first side than the back pressure flow path 77 and communicates with the back pressure flow path 77. Then, around the communication chamber 78 in the control seat 76, plural back pressure communication paths 79 are formed in the circumferential direction, which are through holes penetrating in the second radial direction to communicate the communication chamber 78 and the back pressure chamber 68P.

The control seat 76 configured as described above, together with the control valve 70, constitutes a valve 700 that is provided on a discharge flow path, which will be described later, and varies the area of the discharge flow path.

### Narrowing Member 83

The narrowing member 83 is fitted to the first side than the communication chamber 78 of the control seat 76 and includes a cylinder-shaped cylindrical part 831, and a closing part 832 closing the opening part on the second side in the cylindrical part 831. In the closing part 832, a back pressure orifice flow path 84 is formed to connect an inlet flow path 81, which will be described later, and the communication chamber 78. The back pressure orifice flow path 84 is formed so that the cross section of the oil flow path is smaller than that of the back pressure communication path 79 and the back pressure flow path 77. The back pressure orifice flow path 84 makes it difficult for the oil in the back pressure chamber 68P to return to the inlet flow path 81.

### Communication Part 80

As shown in FIG. 3, the communication part 80 in the first exemplary embodiment includes the inlet flow path 81 for which the oil enters from the communication path L, and a connection part 89 for connecting to the control seat 76.

The inner diameter of the connection part 89 is substantially equal to the outer diameter on the first side of the control seat 76. The end portion on the first side of the control seat 76 is then inserted into the connection part 89. Note that the communication part 80 may be configured to be inserted into the interior of the control seat 76.

### Connection Flow Path Part 90

As shown in FIG. 2, the connection flow path part 90 includes: an inner flow path 91 provided on the second inner side; and outer flow paths 92 provided on the second outer side.

The inner flow path 91 communicates with the outer cylindrical body opening part 12H on the first side and communicates with the inlet flow path 81 of the communication part 80 and the main flow path 53 of the main valve seat 52 on the second side.

The plural outer flow paths 92 are provided in the circumferential direction. Then, the outer flow paths 92 communicate with the case opening part 13H on the first side and communicate with the in-housing flow path 111 on the second side.

### Outer Housing 100C

As shown in FIG. 2, the outer housing 100C is substantially a cylindrical member. The outer housing 100C is fixed to the damper case 13, for example by welding, on the first side.

In addition, the outer housing 100C forms the in-housing flow path 111, which is the oil flow path in the outer housing 100C, on the second outer side of the main valve part 50 and the damping force adjusting part 60.

The in-housing flow path 111 is configured to allow oil flowing out of the second opening part 67H2 of the cap part 67 and oil flowing out of the main flow path 53 of the main valve seat 52 upon opening of the main valve 51 to flow in.

### Adjusting Operation of Damping Force Adjusting Part 60

Next, adjusting operations in the damping force adjusting part 60 will be described.

As shown in FIG. 4, the control valve 70 is pressed against the control seat 76 by pressing the pressing member 63 toward the first side. The pressing force of the pressing member 63, in other words, the thrust of the solenoid part 62, varies according to the amount of current flowing to the solenoid part 62 (see FIG. 2).

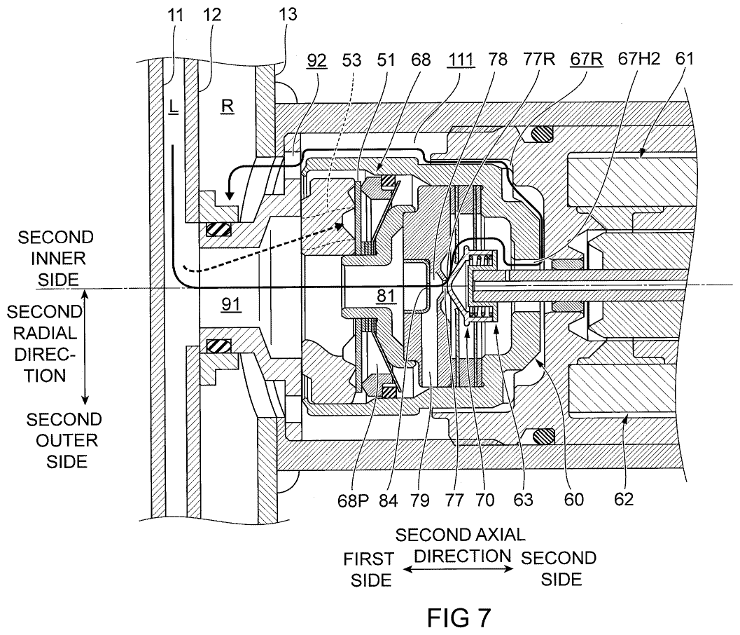

For example, in the damping force adjustment part 60, the state in which the pressing force of the pressing member 63 is maximized is formed. At this time, the control valve 70 is pressed most strongly against the back pressure flow path 77 of the control seat 76, which causes the back pressure flow path 77 to be closed (see FIG. 7).

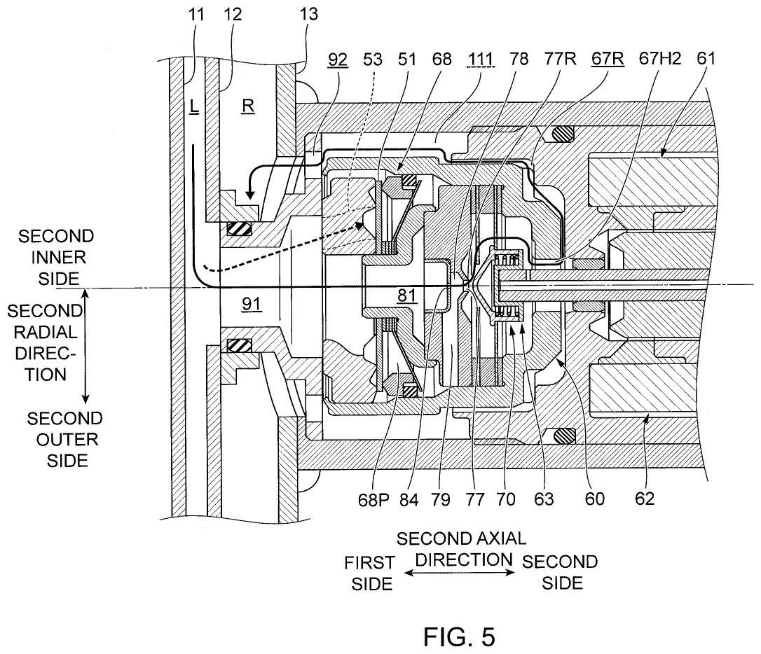

In addition, for example, in the damping force adjustment part 60, the state in which the pressing force of the pressing member 63 is minimized is formed. At this time, in the damping force adjusting part 60, the control valve 70 is away from the back pressure flow path 77, which opens the back pressure flow path 77 (see FIG. 5).

Further, for example, in the damping force adjustment part 60, the state in which the pressing force of the pressing member 63 is between the minimum and maximum is formed. In this state, in the damping force adjusting part 60, the control valve 70 is further from the back pressure flow path 77 than in the maximum pressing force state and closer to the back pressure flow path 77 than in the minimum pressing force state.

Operation of hydraulic shock absorbing device 1

First, the operations of the hydraulic shock absorbing device 1 during the extension stroke will be described.

During the extension stroke, the rod 20 moves to the other side with respect to the cylinder 11. At this time, the piston valve 32 remains closing the piston oil ports 311. In addition, the movement of the piston part 30 to the other side reduces the volume of the second oil chamber Y2. Then, the oil in the second oil chamber Y2 flows from the communicating hole 11H to the communication path L.

Furthermore, the oil flows through the communication path L and the outer cylindrical body opening part 12H, and flows into the damping force generation device 100. Then, in the damping force generation device 100, first, the oil flows into the inner flow path 91 of the connection flow path part 90. After that, in the damping force generation device 100, the damping force is generated at the main valve 51 or the control valve 70. Note that the flow of oil at this time will be described in detail later.

Thereafter, the oil that has flowed through the main valve 51 or the control valve 70 then flows into the in-housing flow path 111. Furthermore, the oil flows through the outer flow path 92 of the connection flow path part 90 and flows into the reservoir chamber R from the case opening part 13H.

In addition, the pressure in the first oil chamber Y1 becomes lower relative to the reservoir chamber R. Therefore, the oil in the reservoir chamber R flows into the first oil chamber Y1 through the bottom part 40.

Next, the operations of the hydraulic shock absorbing device 1 during the compression stroke will be described.

During the compression stroke, the rod 20 moves to the one side relative to the cylinder 11. In the piston part 30, the differential pressure between the first oil chamber Y1 and the second oil chamber Y2 opens the piston valve 32 that closes the piston oil ports 311. The oil in the first oil chamber Y1 then flows into the second oil chamber Y2 through the piston oil ports 311. Here, the rod 20 is disposed in the second oil chamber Y2. Therefore, the oil flowing from the first oil chamber Y1 to the second oil chamber Y2 becomes excessive by the volume of the rod 20. Accordingly, the oil of the amount equivalent to the volume of the rod 20 flows from the communicating hole 11H to the communication path L.

Furthermore, the oil flows through the communication path L and the outer cylindrical body opening part 12H and flows into the damping force generation device 100. Note that the flow of the oil in the damping force generation device 100 is the same as the flow of the oil during the extension stroke described above. In other words, in the hydraulic shock absorbing device 1 of the first exemplary embodiment, the direction of the oil flow in the damping force generation device 100 is the same in both the compression stroke and the extension stroke.

As described above, in the hydraulic shock absorbing device 1, the damping force is generated in the damping force generation device 100 in both the compression stroke and the extension stroke.

Next, the oil flow in the damping force generation device 100 will be described in detail.

### Normal State

The oil flow during the normal state where the solenoid part 62 is energized and the pressing force of the pressing member 63 is applied will be described.

### At Low Speed

FIG. 5 is a diagram showing an example of the oil flow when a moving speed of the piston part 30 (see FIG. 1) is low in the state where the pressing force of the pressing member 63 is minimized.

As shown in FIG. 5, in the case where the moving speed of the piston part 30 is low, the oil flowing through the inner flow path 91 flows into the inlet flow path 81 and the main flow path 53. Here, there is no oil flow to open the main valve 51 in the main flow path 53 due to the low moving speed of the piston part 30.

On the other hand, the oil that has flowed into the inlet flow path 81 flows in the order of the back pressure orifice flow path 84, the communication chamber 78, the back pressure flow path 77, the second opening part 67H2, and the cap flow path 67R, as indicated by the arrows in FIG. 5. The oil then flows from the in-housing flow path 111 into the reservoir chamber R.

As described above, in the case where the moving speed of the piston part 30 is low, the damping force is generated by the oil flow being narrowed by the gap between the round 77R and the control valve 70.

### At High Speed

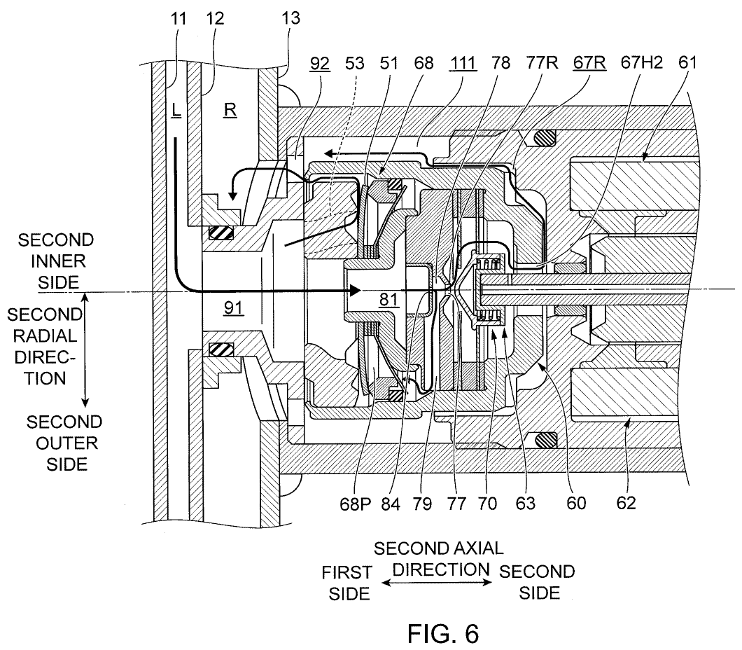

FIG. 6 is a diagram showing an example of the oil flow when the moving speed of the piston part 30 (see FIG. 1) is high in the state where the pressing force of the pressing member 63 is minimized.

As shown in FIG. 6, in the case where the moving speed of the piston part 30 is high, the oil flowing through the inner flow path 91 flows into the inlet flow path 81 and the main flow path 53. The oil that has flowed into the main flow path 53 flows into the reservoir chamber R by opening the main valve 51.

Note that, even in the case where the moving speed is high, similarly to the case of the low speed, the oil that has flowed into the inlet flow path 81 flows to the in-housing flow path 111 while the flow rate is narrowed by the gap between the round 77R and the control valve 70 to generate the differential pressure, and then flows into the reservoir chamber R.

As described above, in the case where the moving speed of the piston part 30 is high, the damping force is mainly generated by the oil flow in the main flow path 53 of the main valve seat 52.

In addition, the oil that has flowed into the inlet flow path 81 transmits pressure to the back pressure chamber 68P through the back pressure orifice flow path 84 and the back pressure communication path 79. However, the back pressure flow path 77, which communicates with the back pressure chamber 68P, is in the open condition by the control valve 70. Therefore, the pressure in the back pressure chamber 68P is low as compared to the case in which the control valve 70 is pressed against the back pressure flow path 77. It is then easier for the main valve 51, which is in contact with the back pressure generation mechanism 68, to open the main flow path 53. Therefore, in the state where the pressing force of the pressing member 63 is minimized, the damping force generated by the oil flow in the main flow path 53 that opens the main valve 51 is smaller than in the state where the pressing force of the pressing member 63 is maximized.

FIG. 7 is a diagram showing an example of the oil flow when a moving speed of the piston part 30 (see FIG. 1) is low in the state where the pressing force of the pressing member 63 is maximized.

### At Low Speed

As shown in FIG. 7, in the case where the moving speed of the piston part 30 is low, the oil flowing through the inner flow path 91 flows into the inlet flow path 81 and the main flow path 53. Here, no oil flow is generated to open the main valve 51 and flow through the main flow path 53 due to the low moving speed of the piston part 30.

On the other hand, the oil that has flowed into the inlet flow path 81 flows to the back pressure orifice flow path 84 and the communication chamber 78, as indicated by the arrows in FIG. 7. The oil then flows through the back pressure flow path 77 while opening the control valve 70. In addition, the oil flows through in the order of the second opening part 67H2 and the cap flow path 67R. The oil then flows from the in-housing flow path 111 into the reservoir chamber R.

As described above, in the case where the moving speed of the piston part 30 is low, the damping force is generated by the oil that flows through the back pressure flow path 77 while opening the control valve 70. The damping force while flowing through the back pressure flow path 77 is large as compared to the case where the control valve 70 is away from the back pressure flow path 77.

### At High Speed

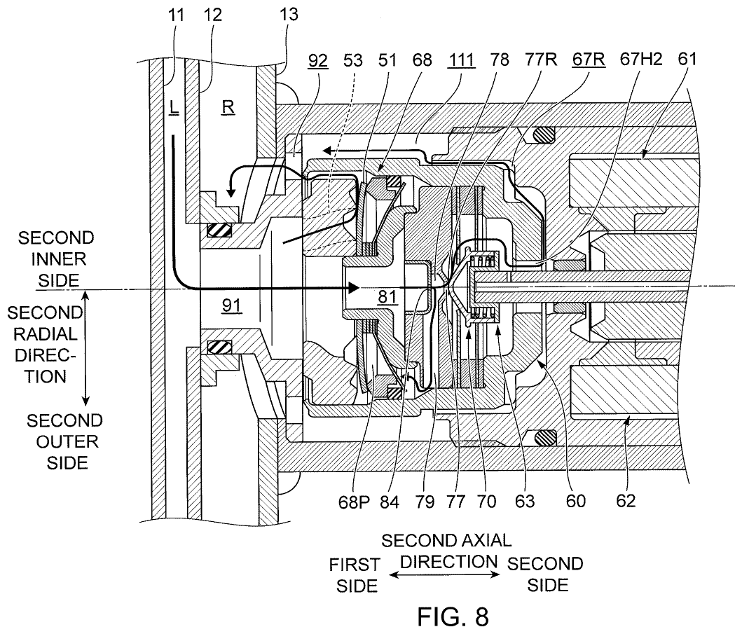

FIG. 8 is a diagram showing an example of the oil flow when a moving speed of the piston part 30 (see FIG. 1) is high in the state where the pressing force of the pressing member 63 is maximized.

As shown in FIG. 8, in the case where the moving speed of the piston part 30 is high, the oil flowing through the inner flow path 91 flows into the inlet flow path 81 and the main flow path 53. The oil that has flowed into the main flow path 53 flows into the reservoir chamber R by opening the main valve 51.

Note that, even in the case where the moving speed is high, similarly to the case of the minimum pressing force of the pressing member 63, the oil that has flowed into the inlet flow path 81 flows to the in-housing flow path 111 while the flow rate is narrowed by the gap between the round 77R and the control valve 70 to generate the differential pressure, and then flows into the reservoir chamber R.

As described above, in the case where the moving speed of the piston part 30 is high, the damping force is mainly generated by the oil flow in the main flow path 53 of the main valve seat 52.

In addition, the oil that has flowed into the inlet flow path 81 transmits pressure to the back pressure chamber 68P through the back pressure orifice flow path 84 and the back pressure communication path 79. The back pressure flow path 77, which communicates with the back pressure chamber 68P, is in the state pressed by the control valve 70. Therefore, the pressure in the back pressure chamber 68P is high as compared to the case in which the back pressure flow path 77 is opened. It is then more difficult for the main valve 51, which is in contact with the back pressure generation mechanism 68, to open the main flow path 53. Therefore, in the state where the pressing force of the pressing member 63 is maximized, the damping force generated by the oil flow in the main flow path 53 that opens the main valve 51 is larger than in the state where the pressing force of the pressing member 63 is minimized.

As described above, the hydraulic shock absorbing device 1 adjusts both the damping force at low speed and the damping force at high speed by operating the pressing member 63. In other words, the hydraulic shock absorbing device 1 adjusts the flow path area of the back pressure flow path 77, which is the flow path of the oil at low speed, and the flow path area of the back pressure flow path 77, which adjusts the pressure in the back pressure chamber 68P related to the flow path area at high speed, by changing the pressing force of the control valve 70 against the control seat 76 by the pressing member 63.

In the above operation example, two patterns, the state in which the pressing force of the pressing member 63 is the minimum and the state in which the pressing force is the maximum, have been described, but are not limited to the aforementioned two patterns. The amount of current for the solenoid part 62, in other words, the pressing force of the pressing member 63 can be set arbitrarily within an adjustable range according to the thrust of the solenoid part 62. With this setting, then, the damping force adjusting part 60 can adjust the damping force at low speed and the damping force at high speed in plural phases.

### Abnormal State

Next, the oil flow during the abnormal state where the solenoid part 62 is not energized and the pressing force of the pressing member 63 is not applied will be described. As the case in which the solenoid part 62 becomes de-energized, a case can be exemplified, in which the current supply to the coil of the solenoid part 62 stops due to a wire break, etc.

FIG. 9 is a diagram showing an example of the oil flow when the moving speed of the piston part 30 (see FIG. 1) is low in the state where a solenoid part 62 is not energized.

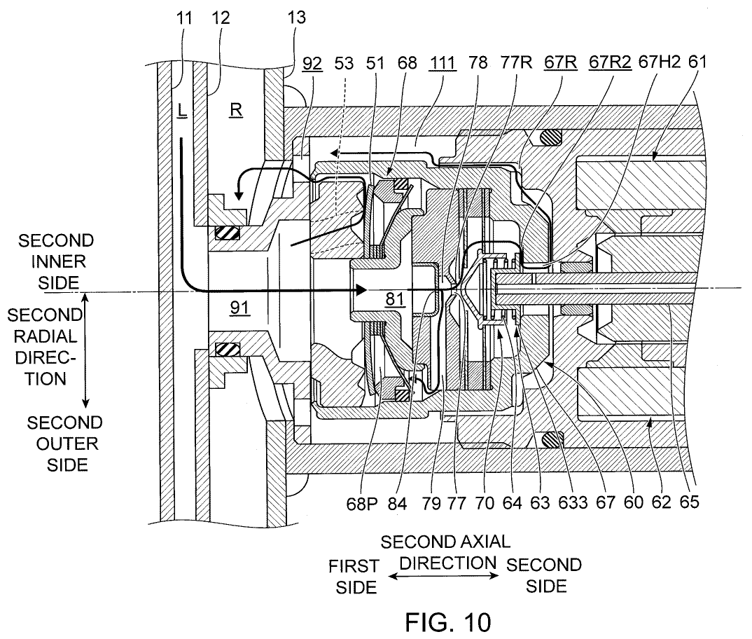

FIG. 10 is a diagram showing an example of the oil flow when the moving speed of the piston part 30 is high in the state where the solenoid part 62 is not energized.

As shown in FIGS. 9 and 10, when the solenoid part 62 is not energized, the plunger 65 is pushed back toward the second side by the coil spring 64. With this, the pressing member 63, which is fixed to the plunger 65, is pressed against the cap part 67.

### At Low Speed

As shown in FIG. 9, in the case where the moving speed of the piston part 30 is low, the oil that has flowed into the inlet flow path 81 flows in the order of the back pressure orifice flow path 84, the communication chamber 78, the back pressure flow path 77, the cap orifice flow path 67R2, the second opening part 67H2, and the cap flow path 67R. The oil then flows from the in-housing flow path 111 into the reservoir chamber R.

Then, in the case where the moving speed of the piston part 30 is low, the damping force is generated by the oil flow in the cap orifice flow path 67R2 formed between the flange part 633 of the pressing member 63 and the cap part 67.

### At High Speed

As shown in FIG. 10, in the case where the moving speed of the piston part 30 is high, the oil that has flowed through the inner flow path 91 flows into the inlet flow path 81 and the main flow path 53. The oil that has flowed into the main flow path 53 flows into the reservoir chamber R by opening the main valve 51.

Note that, even in the case where the moving speed is high, similarly to the case of the low speed, the oil that has flowed into the inlet flow path 81 flows to the in-housing flow path 111 while the flow rate is narrowed by the cap orifice flow path 67R2 to generate the differential pressure, and further flows into the reservoir chamber R.

As described above, in the case where the moving speed of the piston part 30 is high, the damping force is mainly generated by the oil flow in the main flow path 53 of the main valve seat 52.

Here, the oil that has flowed into the inlet flow path 81 transmits pressure to the back pressure chamber 68P through the back pressure orifice flow path 84 and the back pressure communication path 79. The back pressure chamber 68P communicates with the in-housing flow path 111 via the back pressure flow path 77. The oil flow between the back pressure chamber 68P and the in-housing flow path 111 has to pass through the cap orifice flow path 67R2. The narrowing of the oil flow by the cap orifice flow path 67R2 then suppresses the oil flow out of the back pressure chamber 68P and maintains the pressure in the back pressure chamber 68P at a level higher than that in the minimum pressing force state of the pressing member 63 shown in FIG. 6. It is then relatively more difficult for the main valve 51, which is in contact with the back pressure generation mechanism 68, to open the main flow path 53. Therefore, in the state where the solenoid part 62 is not energized, the damping force generated by the oil flow in the main flow path 53 that opens the main valve 51 is relatively large.

As described above, in the hydraulic shock absorbing device 1 of the first exemplary embodiment, both the damping force at low speed and the damping force at high speed are set relatively high even in the abnormal state in which the solenoid part 62 is not energized.

### Difference Between Normal State and Abnormal State

When the resultant of the force of the oil passing through the back pressure flow path 77, which moves the control valve 70 toward the second side, and the force of the coil spring 64 exceeds the pressing force of the pressing member 63, the control valve 70 moves toward the second side even though the thrust of the solenoid part 62 is generated. In particular, when the thrust of the solenoid part 62 is relatively small, such as the state in which the pressing force of the pressing member 63 is the minimum shown in FIGS. 5 and 6, the control valve 70 temporarily moves toward the second side if the pressure of the oil passing through the back pressure flow path 77 increases.

In the damping force generation device 100, even if the control valve 70 moved toward the second side, the regulation member 72 suppresses the movement of the control valve 70 toward the second side. In other words, the protruding part 71 comes into contact with the regulation member 72, which causes the control valve 70 to receive a force from the regulation member 72 in the direction toward the first side, thereby suppressing the movement toward the second side.

In addition, the cylindrical part 631 and the bottom part 632 of the pressing member 63 are disposed at the second inner side of the cylindrical part 701 and the conical part 702 of the control valve 70, and the diameter of the outer circumferential portion of the flange part 633 of the pressing member 63 is less than or equal to the outer diameter of the cylindrical part 701 of the control valve 70, and therefore, the pressure member 63 is less likely to receive the force of the oil passing through the back pressure flow path 77 and flowing toward the second opening part 67H2. As a result, the movement of the pressing member 63 toward the second side is also suppressed, which makes it easy for the pressing member 63 to remain stable in the operating position in the normal state and makes it difficult for the pressing member 63 to be pressed against the cap part 67, which is the operating position in the abnormal state.

Thus, in the damping force generation device 100 of the exemplary embodiment, in the normal state, even if the resultant of the force of the oil moving the control valve 70 toward the second side and the force of the coil spring 64 exceeds the thrust of the solenoid part 62, it is difficult for the pressing member 63 to be pressed against the cap part 67. In other words, in the damping force generation device 100, unlike the abnormal state operation, it is difficult for the pressing member 63 to be pressed against the cap part 67 in the normal state. Thus, according to the damping force generation device 100, it is possible to prevent the operation for the abnormal state even though the mechanism can operate normally, and also to enable the operation for the abnormal state in case of occurrence of abnormality as the mechanism. In addition, even if the flow path cross-sectional area of the cap orifice flow path 67R2 is changed to adjust the damping force generated during the abnormal state, this change can be prevented from affecting the damping force during the normal state.

As described above, the damping force generation device 100 includes: the main valve 51 (an example of a main valve) that restricts the flow of oil (an example of a fluid) and generates the damping force; the back pressure chamber 68P that applies pressure to the main valve 51 in the closing direction; and the flow path (hereinafter referred to as “discharge flow path” in some cases) that allows the oil to flow from the back pressure chamber 68P. The discharge flow path includes the back pressure communication path 79, the communication chamber 78, the back pressure flow path 77, the second opening part 67H2, the cap flow path 67R, and the in-housing flow path 111. In addition, the damping force generation device 100 includes the valve 700 that is provided on the discharge flow path, and has the control valve 70 (an example of a valve body) which varies the area of the discharge flow path, and a control seat 76 (an example of a valve seat) on which the control valve 70 can be seated. In addition, the damping force generation device 100 includes the pressing member 63 that can contact the side opposite to the side facing the control seat 76 of the control valve 70 and can apply the pressing force in the direction that the control valve 70 is pressed against the control seat 76. The damping force generation device 100 also includes the solenoid part 62 as an example of an actuator part capable of generating thrust between a first position and a second position according to the current to be supplied. The first position can be exemplified as the position shown in FIG. 7, where the pressing member 63 is closest to the control seat 76. Moreover, the second position can be exemplified as the position shown in FIG. 9, where the pressing member 63 is farthest from the control seat 76. Assuming that the damping force generation device 100 does not include the regulation member 72, in the case where the pressure of the oil passing through the back pressure flow path 77 is high, even if the pressing member 63 is in the second position shown in FIG. 9, the control valve 70 is in a state where the end surface 705 on the second side of the cylindrical part 701 is in contact with the flange part 633 of the pressing member 63. In this state, in other words, when the pressing member 63 is in the second position shown in FIG. 9, the position of the control valve 70, where the end surface 705 on the second side of the cylindrical part 701 is in contact with the flange part 633 of the pressing member 63, is virtually referred to as the second position of the control valve 70. The solenoid part 62 applies thrust to the pressing member 63 and presses thereof from the second position toward the first position. In addition, the damping force generation device 100 includes the regulation member 72 that regulates the movement of the control valve 70 so that the pressing member 63 does not reach the second position even if the control valve 70 moves in the direction that the pressing member 63 moves toward the second position due to the pressure of the oil passing through the discharge flow path. In other words, the damping force generation device 100 includes a housing that is formed in a tubular shape to accommodate the pressing member 63 and the control valve 70, and protrusions are formed on the inner circumferential surface. In other words, an object constituted by the cap part 67, the first spacer member 73A and the second spacer member 73B (an example of a pair of spacers), etc. is formed into a tubular shape that accommodates the pressing member 63 and the control valve 70, as well as the regulation member 72 protrudes toward the second inner side than the inner circumferential surface of the first spacer member 73A and the second spacer member 73B. Then, the regulation member 72 and the protruding part 71 of the control valve 70 functions as an example of a regulation part that regulates the movement of the control valve 70 toward the second position in a third position between the first position and the second position. The third position can be exemplified as the position shown in FIG. 9, where the protruding part 71 of the control valve 70 hits against the regulation member 72.

According to the damping force generation device 100, even if the pressure of the oil passing through the back pressure flow path 77 is high, and the control valve 70 moves toward the second side to move the pressing member 63 toward the second side, the movement of the control valve 70 is regulated by the regulation member 72, so that the pressing member 63 does not reach the position farthest from the control seat 76. The pressing member 63 reaches the position farthest from the control seat 76 when the current supplied to the solenoid part 62 is zero, in other words, when the solenoid part 62 is de-energized and the thrust of the solenoid part 62 becomes zero, which is the abnormal state. Therefore, according to the damping force generation device 100, in the normal state in which the mechanism can operate normally, even if the pressure of the oil passing through the back pressure flow path 77 is high, the abnormal state operations are suppressed.

The damping force generation device 100 further includes the coil spring 64 (an example of a moving member) that generates force on the pressing member 63 in the direction away from the control valve 70 and can move the pressing member 63 to the second position in the case where the movement of the control valve 70 is regulated by the regulation member 72. Thus, in the abnormal state where the thrust of the solenoid part 62 becomes zero, it is possible to press the pressing member 63 against the cap part 67 with high accuracy. Therefore, when an abnormality actually occurs in the mechanism, it is possible to perform the operations for the abnormal state with high accuracy.

The coil spring 64 is an example of the elastic member disposed between the control valve 70 and the pressing member 63. Therefore, it is possible to make the damping force adjusting part 60 a simplified configuration.

The pressing member 63 is fixed to the plunger 65 (an example of a driving member) of the solenoid part 62. Therefore, it is possible to adjust the damping force with high accuracy according to the current supplied to the solenoid part 62, such that, for example, it is possible to press the pressing member 63 against the cap part 67 with high accuracy in the abnormal state where the thrust of the solenoid part 62 becomes zero.

The pressing member 63 includes: the cylindrical part 631 (an example of a tubular part); the bottom part 632 covering the opening part of the cylindrical part 631 on the control seat 76 side; and the flange part 633 (an example of an applying part) that protrudes from the outer circumferential surface of the cylindrical part 631 toward the second outer side (an example of an outside) and applies the pressing force to the control valve 70. The control valve 70 then accommodates the cylindrical part 631 and the bottom part 632 of the pressing member 63. Therefore, the pressing member 63 is less likely to receive the pressure of the oil passing through the back pressure flow path 77. As a result, in the normal state, even if the pressure of the oil passing through the back pressure flow path 77 is high, since the movement of the pressing member 63 toward the second side is suppressed, it is easy for the pressing member 63 to remain stable in the operating position, and operations for the abnormal state are prevented from being performed.

As described above, the damping force generation device 100 includes: the valve 600 as an example of a first valve that restricts the flow of oil (an example of a fluid) and generates the damping force; the back pressure chamber 68P that applies pressure to the main valve 51 in the closing direction; and the discharge flow path that allows the oil to flow from the back pressure chamber 68P. In addition, the damping force generation device 100 includes the valve 700 as an example of a second valve that is provided on the discharge flow path, and has the control valve 70 (an example of a valve body) which varies the area of the discharge flow path, and a control seat 76 (an example of a valve seat) on which the control valve 70 can be seated. The damping force generation device 100 also includes: the pressing member 63 and the plunger 65 (an example of a pressing part) that can contact the side opposite to the side facing the control seat 76 of the control valve 70; and the coil spring 64 (an example of a biasing member) that causes bias in a direction in which the control seat 76 and the control valve 70 approach each other. In addition, the damping force generation device 100 includes the solenoid part 62 (an example of an actuator part) that applies thrust, which heads for the control seat 76, to the control valve 70 through the pressing member 63 and the plunger 65.

Here, the plunger 65 is a rod that is fixed to a moving core 621 (an example of a movable element) of the solenoid part 62 and receives thrust, and the pressing member 63 is attached to the plunger 65 and can contact the side opposite to the side facing the control seat 76 of the control valve 70. The coil spring 64 is then disposed between the control valve 70 and the pressing member 63, and causes bias in the direction in which the control seat 76 and the control valve 70 approach each other and also in the direction in which the pressing member 63 and the control valve 70 separate from each other.

In addition, the damping force generation device 100 further has a regulation part (for example, the regulation member 72 and the protruding part 71 of the control valve 70) that suppresses the separation of the control valve 70 by equal to or more than a predetermined amount relative to the control seat 76. Therefore, according to the damping force generation device 100, in the normal state in which the mechanism can operate normally, even if the pressure of the oil passing through the back pressure flow path 77 is high, the abnormal state operations are suppressed.

In addition, in the damping force generation device 100, the flange part 633 of the pressing member 63 contacts the end surface 705 on the second side of the cylindrical part 701 of the control valve 70. Asperities should be formed on a contact surface of the flange part 633 of the pressing member 63, which contacts the control valve 70, or on a contact surface of the end surface 705 on the second side of the control valve 70, which contacts the pressing member 63. The asperities can be exemplified to be configured with the contact surface and concave portions recessed from the contact surface. Alternatively, the asperities may be formed by not applying polishing. For example, the asperities of flange part 633 of pressing member 63 may be a state in which no polishing has been applied to the sheet metal after press working or may correspond to the roughness of the surface after press working. Since at least one of the contact surfaces has the asperities, the inside and outside of a chamber formed by the pressing member 63 and the control valve 70 communicate through the asperities, which equalizes the pressure, and it is possible to prevent the two contact surfaces from sticking together due to a pressure difference. As a result, for example, in the abnormal state where the thrust of the solenoid part 62 becomes zero, it is possible to press the pressing member 63 against the cap part 67 with high accuracy.

### Second Exemplary Embodiment

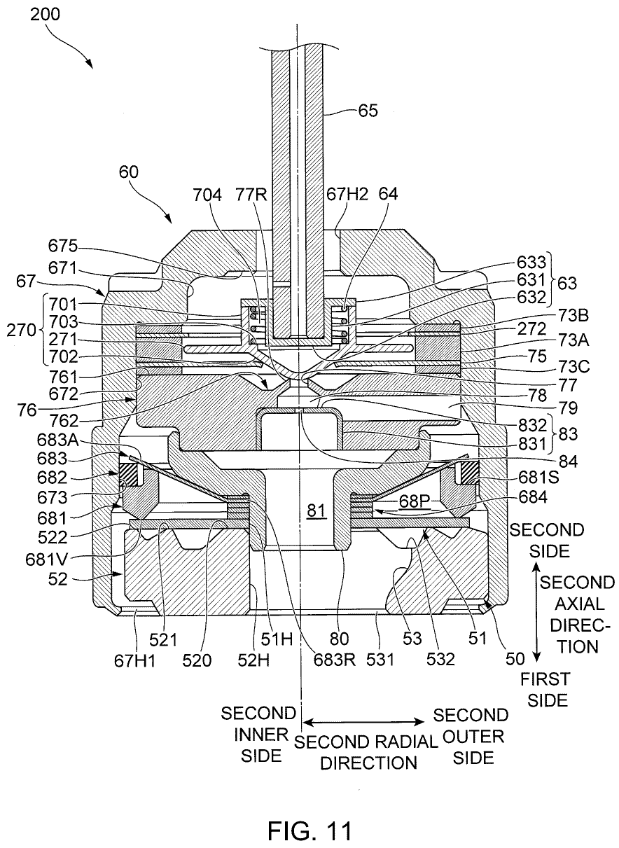

FIG. 11 is a diagram showing an example of an overall configuration of a damping force generation device 200 related to a second exemplary embodiment.

The damping force generation device 200 related to the second exemplary embodiment differs from the damping force generation device 100 related to the first exemplary embodiment in a control valve 270 corresponding to the control valve 70 and a regulation member 272 corresponding to the regulation member 72. Hereinafter, the points that differ from the first exemplary embodiment will be described. In the first and second exemplary embodiments, the same reference signs are used for the same components, and detailed descriptions thereof are omitted.

The regulation member 272 differs from the regulation member 72 in that the regulation member 272 does not have the arm parts 722 and only has a part corresponding to the annular part 721. Then, the inner diameter of the regulation member 272 is smaller than those of the first spacer member 73A and the second spacer member 73B, and the regulation member 272 protrudes toward the second inner side than the first spacer member 73A and the second spacer member 73B.

The control valve 270 differs from the control valve 70 in a protruding part 271 corresponding to the protruding part 71. Unlike the protruding part 71, the protruding part 271 is not formed around the entire circumference, but the plural (for example, four) protruding parts 271 are formed around the cylindrical part 701. The plural protruding parts 271 are provided at regular intervals in the circumferential direction of the cylindrical part 701. The size of the protruding part 271 in the circumferential direction gradually decreases from the second inner side toward the second outer side. The diameter of the virtual circle formed by the tip end of the second outer side at the plural protruding parts 271 is larger than the inner diameter of the regulation member 272 and smaller than the inner diameter of the first spacer member 73A and the second spacer member 73B.

In the damping force generation device 200 configured as described above, even if the control valve 270 has moved toward the second side upon receiving the pressure of the oil passing through the back pressure flow path 77, the control valve 270 is prevented from moving toward the second side by the protruding parts 271 coming into contact with the regulation member 272.

As described above, the damping force generation device 200 includes the valve 700 that is provided on the back pressure flow path 77 and has the conical part 702 of the control valve 270 (an example of the valve body) which varies the area of the back pressure flow path 77 and the control seat 76 (an example of the valve seat) on which the control valve 270 can be seated. In addition, the damping force generation device 200 includes the protruding parts 271 that regulate the movement of the control valve 270 so that the pressing member 63 does not reach the second position even if the control valve 270 moves in the direction that the pressing member 63 moves toward the second position due to the pressure of the oil passing through the back pressure flow path 77. In other words, the damping force generation device 200 includes a housing that is formed in a tubular shape to accommodate the pressing member 63 and the control valve 270, and protrusions are formed on the inner circumferential surface. In other words, an object constituted by the cap part 67, the first spacer member 73A and the second spacer member 73B, etc. is formed into a tubular shape that accommodates the pressing member 63 and the control valve 270, as well as the regulation member 272 protrudes toward the second inner side than the inner circumferential surface of the first spacer member 73A and the second spacer member 73B. Then, the regulation member 272 and the protruding parts 271 of the control valve 270 function as an example of the regulation part that regulates the movement of the conical part 702 of the control valve 270 toward the second position in a third position between the first position and the second position. According to the damping force generation device 200 configured as described above, in the normal state in which the mechanism can operate normally, even if the pressure of the oil passing through the back pressure flow path 77 is high, the abnormal state operations are suppressed.

### Third exemplary embodiment

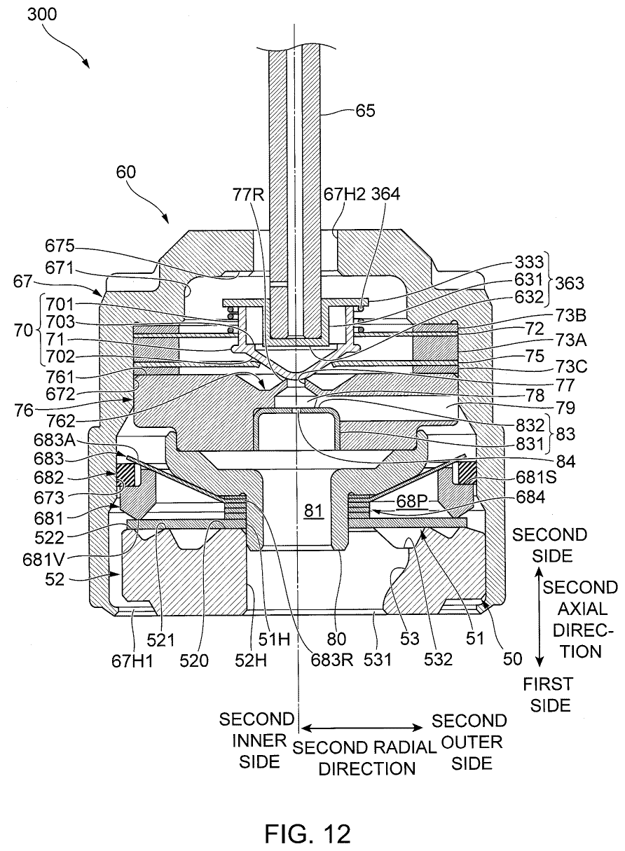

FIG. 12 is a diagram showing an example of an overall configuration of a damping force generation device 300 related to a third exemplary embodiment.

The damping force generation device 300 related to the third exemplary embodiment differs from the damping force generation device 100 related to the first exemplary embodiment in a pressing member 363 corresponding to the pressing member 63 and a coil spring 364 corresponding to the coil spring 64. Hereinafter, the points that differ from the first exemplary embodiment will be described. In the first and third exemplary embodiments, the same reference signs are used for the same components, and detailed descriptions thereof are omitted.

The pressing member 363 differs from the pressing member 63 in the point that a flange part 333 corresponding to the flange part 633 protrudes toward the second outer side than the cylindrical part 701 of the control valve 70.

The coil spring 364 is disposed in a position different from the coil spring 64. More specifically, the coil spring 364 contacts the regulation member 72 on the first side and the flange part 333 of the pressing member 363 on the second side. The coil spring 364 then applies a force to each of the pressing member 363 and the regulation member 72 in the direction in which the pressing member 363 and the regulation member 72 are separated from each other.

As described above, the damping force generation device 300 includes the regulation member 72 that regulates the movement of the control valve 70 so that the pressing member 363 does not reach the cap part 67 even if the control valve 70 moves in the direction that the pressing member 363 moves toward the second side due to the pressure of the oil passing through the back pressure flow path 77. The damping force generation device 300 also includes the coil spring 364 (an example of a moving member) that generates force on the pressing member 363 in the direction away from the control valve 70 and can move the pressing member 363 to the cap part 67 even though the movement of the control valve 70 is regulated by the regulation member 72. Then, the coil spring 364 is an example of the elastic member disposed between the pressing member 363 and the regulation member 72. Therefore, when an abnormality actually occurs in the mechanism, it is possible to perform the operations for the abnormal state with high accuracy. Also, in the damping force generation device 300 thus configured, it is possible to prevent the operation for the abnormal state even though the mechanism can operate normally, and also to enable the operation for the abnormal state in case of occurrence of abnormality in the mechanism.

### Fourth Exemplary Embodiment

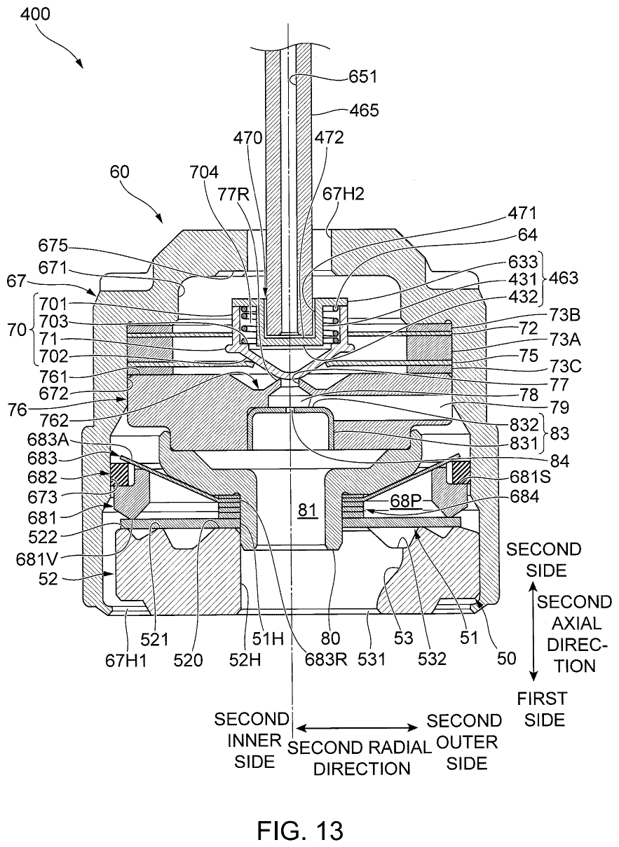

FIG. 13 is a diagram showing an example of an overall configuration of a damping force generation device 400 related to a fourth exemplary embodiment.

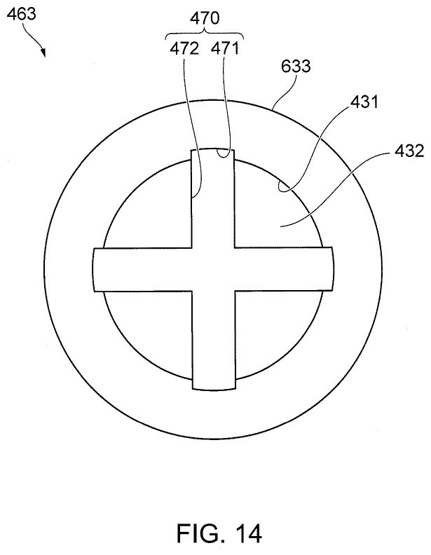

FIG. 14 is a diagram showing an example of a pressing member 463 viewed from a second side to a second axial direction.

The damping force generation device 400 related to the fourth exemplary embodiment differs from the damping force generation device 100 related to the first exemplary embodiment in a plunger 465 corresponding to the plunger 65 and the pressing member 463 corresponding to the pressing member 63. Hereinafter, the points that differ from the first exemplary embodiment will be described. In the first and fourth exemplary embodiments, the same reference signs are used for the same components, and detailed descriptions thereof are omitted.

The plunger 465 differs from the plunger 65 in the point that the communicating hole 652 is not formed.

The pressing member 463 includes a cylindrical part 431 corresponding to the cylindrical part 631 and a bottom part 432 corresponding to the bottom part 632. The pressing member 463 then differs from the pressing member 63 in the point that the cylindrical part 431 and the bottom 432 do not close the opening portion on the first side of the through hole 651 of the plunger 465. In other words, the pressing member 463 has an introduction path 470 that allows the pressure outside the portion on the first side than the first bearing 664 (see FIG. 2) of the plunger 465 to communicate with the through hole 651 of the plunger 465. The introduction path 470 is configured with a first groove 471 that recesses toward the second outer side from the inner circumferential surface of the cylindrical part 431 and extends in the second axial direction and a second groove 472 that recesses toward the first side from the surface on the second side of the bottom part 432 and extends in the second radial direction. It can be exemplified that the first groove 471 is formed over the entire second axial direction of the cylindrical part 431, and the second groove 472 is formed over the entire second radial direction of the bottom part 432. In the example shown in FIG. 14, plural first grooves 471 and second grooves 472 are formed in the circumferential direction. However, the only one first groove 471 and the only one second groove 472 may be formed in the circumferential direction.

As described above, the damping force generation device 400 includes: the valve 600 (see FIG. 2) as an example of a first valve that restricts the flow of oil and generates the damping force; the back pressure chamber 68P that applies pressure to the main valve 51 in the closing direction; and the discharge flow path that allows the oil to flow from the back pressure chamber 68P. In addition, the damping force generation device 400 includes the valve 700 (see FIG. 2) that is provided on the discharge flow path and has the control valve 70 which varies the area of the discharge flow path, and the control seat 76 on which the control valve 70 can be seated. The damping force generation device 400 also includes: the pressing member 463 and the plunger 465 that can contact the side opposite to the side facing the control seat 76 of the control valve 70; and the solenoid part 62 (see FIG. 2) that applies thrust, which heads for the control seat 76, to the control valve 70 through the pressing member 463 and the plunger 465. The plunger 465 is a rod that is fixed to a moving core 621 (see FIG. 2) of the solenoid part 62 and receives thrust, and the pressing member 463 is attached to the plunger 465 and can contact the side opposite to the side facing the control seat 76 of the control valve 70. The plunger 465 has the through hole 651 formed therein that penetrates from one side (for example, the first side) to the other side (for example, the second side). The pressing member 463 has the cylindrical part 431 and the bottom part 432 that cover the predetermined range of the plunger 465, and at least one of the facing surfaces of the plunger 465 and the pressing member 463 has the induction path 470 that allows the pressure downstream of the valve 700 to communicate with the through hole 651.

According to the damping force generation device 400, the through hole 651 of the plunger 465 and the introduction path 470 of the pressing member 463 allow the outside of the portion of the plunger 465, which is on the first side than the first bearing 664 (see FIG. 2), and the portion on the second inner side of the second fixed part 662, which is on the second side than the second bearing 665 (see FIG. 2), to have the same pressure. As a result, the magnitude of the damping force generated by the damping force generation device 400 is precisely adjusted.

The pressing member 463 can be molded by applying press working to sheet metal. The pressing member 463 can be molded by, for example, applying a drawing to sheet metal with a metal mold that has an outer shape following the shape of the inner circumferential surface of the cylindrical part 431, the surface on the second side of the bottom part 432, the first groove 471, and the second groove 472.

Here, in the damping force generation device 100 related to the first exemplary embodiment, by forming the communicating hole 652 in the plunger 65, the outside of the portion of the plunger 65, which is on the first side than the first bearing 664, and the portion on the second inner side of the second fixed part 662, which is on the second side than the second bearing 665, have the same pressure. Then, in order to form the communicating hole 652 in the plunger 65, it is necessary to carry out hole boring to a cylindrical member, whose center line direction is in the second axial direction, in the direction intersecting the center line direction; thereby the manufacturing procedure increases, and there is a possibility that the load in the bending direction caused by the hole boring adversely affects the accuracy of the plunger 65.

In contrast thereto, according to the damping force generation device 400, the plunger 465 can be easily molded because there is no need to form a hole, which corresponds to the communicating hole 652 related to the first exemplary embodiment, in the plunger 465. On the other hand, it is possible to make the effort to mold the pressing member 463 same as the effort to mold the pressing member 63 related to the first exemplary embodiment. The shape of the metal mold for molding the pressing member 463 should be different from the shape of the metal mold for molding the pressing member 63.

Therefore, according to the damping force generation device 400, productivity can be increased.

Note that, in the fourth exemplary embodiment described above, by forming the first groove 471 and the second groove 472 in the pressing member 463, the introduction path 470 that allows the outside of the plunger 465 and the through hole 651 in the plunger 465 to communicate with each other is constituted, but is not particularly limited to such a mode.

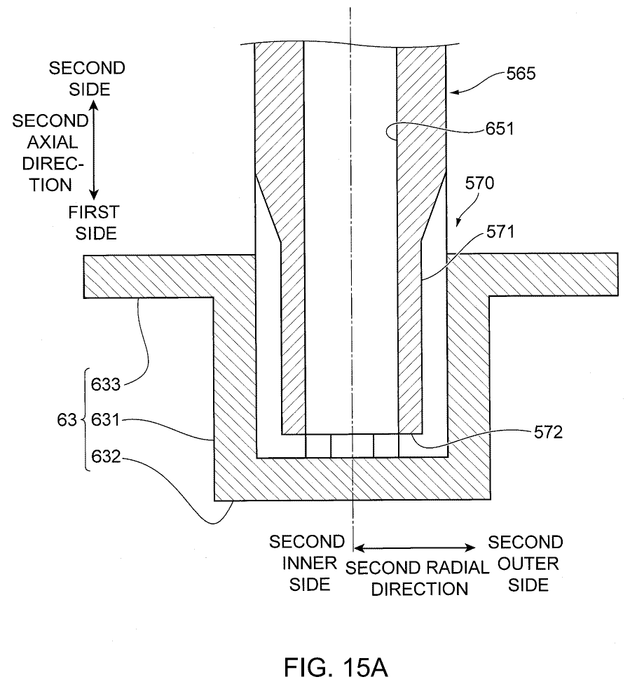

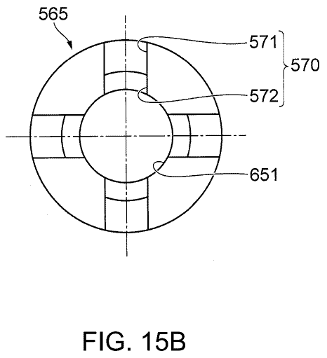

FIG. 15A is a diagram showing an example of an overall configuration of the pressing member 63 and a plunger 565 related to a modified example. FIG. 15B is an example of a diagram of the plunger 565 related to the modified example viewed from the first side to the second axial direction.

The plunger 565 differs from plunger 465 in the point that an introduction path 570, which allows the outside of the plunger 565 and the through hole 651 in the plunger 565 to communicate with each other, is formed on the outer circumferential surface of the end portion on the first side and the end surface. The introduction path 570 is configured with a first groove 571 that recesses toward the second inner side from the outer circumferential surface of the plunger 565 and extends in the second axial direction and a second groove 572 that recesses toward the second side from the end surface on the first side and extends in the second radial direction. The first groove 571 is formed so that the end surface on the first side of the plunger 565 is in contact with the bottom part 632 of the pressing member 63 and located closer to the second side than the flange part 633, and the second groove 572 is formed over the entire second radial direction. In addition, in the example shown in FIGS. 15A and 15B, plural first grooves 571 and second grooves 572 are formed in the circumferential direction. However, the only one first groove 571 and the only one second groove 572 may be formed in the circumferential direction.

By using the plunger 565 configured as described above, even if the pressing member 63 related to the first exemplary embodiment is used, the outside of the portion of the plunger 565, which is on the first side than the first bearing 664 (see FIG. 2), and the portion on the second inner side of the second fixed part 662 (see FIG. 2), which is on the second side than the second bearing 665 (see FIG. 2), have the same pressure. As a result, the magnitude of the damping force is precisely adjusted.

### REFERENCE SIGNS LIST

1 Hydraulic shock absorbing device
10 Cylinder part
11 Cylinder
20 Rod
30 Piston part
51 Main valve
62 Solenoid part (an example of the actuator part)
63,363,463 Pressing member
64,364 Coil spring (an example of the biasing member)
65,465,565 Plunger
68P Back pressure chamber
70 Control valve (an example of the valve body)
72 Regulation member (an example of the regulation part)
76 Control seat (an example of the valve seat)
77 Back pressure flow path
100, 200, 300 Damping force generation device
270 Control valve
271 Protruding part
470 Introduction path
621 Moving core (an example of the movable element)
631 Cylindrical part
632 Bottom part
633 Flange part
651 Through hole
700 Valve
702 Conical part
600 Valve (an example of the first valve)
700 Valve (an example of the second valve)

What is claimed is:

1. A damping force generation device comprising:
a first valve restricting flow of a fluid and generating a damping force;
a back pressure chamber applying pressure in a closing direction to the first valve;
a flow path through which the fluid flows out of the back pressure chamber;
a second valve provided on the flow path and including a valve body capable of varying an area of the flow path and a valve seat on which the valve body can be seated;
a pressing part capable of contacting a side of the valve body opposite to a side thereof facing the valve seat;
a biasing member causing bias in a direction in which the valve seat and the valve body approach each other; and
an actuator part applying thrust to the valve body through the pressing part, the thrust heading to the valve seat.

2. The damping force generation device according to claim 1, wherein
the pressing part comprises
a rod-shaped plunger fixed to a movable element of the actuator part and receiving the thrust, and
a pressing member attached to the plunger and capable of contacting the opposite side of the valve body.

3. The damping force generation device according to claim 2, wherein the biasing member is disposed between the valve body and the pressing member and causes bias in the direction in which the valve seat and the valve body approach each other and also in a direction in which the pressing member and the valve body separate from each other.

4. The damping force generation device according to claim 2, further comprising:
a regulation part suppressing separation of the valve body by equal to or more than a predetermined amount from the valve seat.

5. The damping force generation device according to claim 2, wherein asperities are formed on a contact surface of the pressing member or the valve body, which contacts the other.

6. The damping force generation device according to claim 2, wherein
the plunger has a through hole formed therein penetrating from one side to the other side, and
the pressing member includes a cover part covering a predetermined range of the plunger and closing one end of the through hole.

7. The damping force generation device according to claim 6, wherein an introduction path is formed on at least one of facing surfaces of the plunger and the cover part, the introduction path allowing pressure downstream of the second valve to communicate with the through hole.
